(19) United States
(12) Patent Application Publication
(10) Pub. No.: US 2009/0086568 A1
(43) Pub. Date: Apr. 2, 2009

(54) CONTINUOUS BI-METALLIC TWIN BORE BARREL FOR SCREW EXTRUDER AND METHOD OF MAKING SAME

(75) Inventors: George A. Holmes, West Chicago, IL (US); Tadeusz Rybka, Streamwood, IL (US)

Correspondence Address: FRANCISSEN PATENT LAW, P.C., 53 W. JACKSON BLVD, SUITE # 1320, CHICAGO, IL, 60604, US

(73) Assignee: C.D.L. Technology, Inc., Addison, IL (US)

(21) Appl. No.: 12/236,298

(22) Filed: Sep. 23, 2008

Related U.S. Application Data
(60) Provisional application No. 60/976,001, filed on Sep. 28, 2007.

(51) Int. Cl. A21C 1/06; B21D 35/00

(52) U.S. Cl. 366/85; 72/341

(57) ABSTRACT

A continuous bi-metallic twin bore barrel is produced by forming first and second single bore barrels, centrifugally lining the bores of the single bore barrels with a bi-metallic liner, heating the single bore barrels to harden the linings, fastening each single bore barrel into a barrel machining jig, and cutting each single bore barrel along its length to expose its bore. The barrel machining jigs are fastened together such that two single bore barrels are positioned adjacent and in contact with one another and their bores are in communication with one another. The two single bore barrels are seal welded together to form a twin bore barrel. The twin bore barrel is removed from the jigs and clamped along its length.

### CROSS-REFERENCE TO RELATED PATENT APPLICATIONS

This patent application claims the benefit of U.S. Provisional Patent Application No. 60/976,001 filed Sep. 28, 2007.

### FIELD OF THE INVENTION

This invention pertains to the field of extrusion equipment and, more particularly, to twin screw extruders.

### BACKGROUND OF THE INVENTION

Extruders, such as extruders for extruding plastic material into a molten stream of plastic material, have been known and used for some time. One particular use of such an extruder is in connection with a pelletizer assembly which is mounted to the end of the extruder. In such a combination of an extruder and a pelletizer, a die having a plurality of holes therein is mounted at the end of the extruder and at the entrance to the pelletizer assembly and forms part of both. The pelletizer then includes a rotating cutter assembly having cutting blades positioned adjacent the die face from which streams of molten plastic material flow. The rotating cutter assembly cuts the streams of plastic material into pellets of various sizes depending upon the extrusion flow rate through the holes in the die and the speed of rotation of the cutter assembly.

Single bore barrel extruders typically are formed in one continuous piece by a process of honing a bore through a single piece of metal. The honing process results in a straight and precise circular bore. A second metal is then deposited on the inside of the circular bore, e.g. through centrifugal deposition, to form a wear resistant liner. The piece of metal is then subjected to a heating process to harden the metals and form a centrifugally lined bi-metallic extrusion barrel. Because of the accuracy of the honing process, single barrel extruders are substantially unlimited in terms of their length.

Because single bore barrel extruders are typically one single piece, an external heating and cooling sleeve is used to control the temperature of the plastic inside the extruder bore. The external sleeves are typically clam shell type jackets where the heating and cooling systems are integrated together, which are highly efficient and accurate in maintaining the temperature in the extruder. Because it is a single piece, there are no alignment issues with a single barrel extruder.

Some examples of single bore barrel extruders are shown in U.S. Pat. Nos. 5,190,771; 5,267,787; 5,678,442; 5,823,668; 6,705,752; and 6,869,211.

Twin bore barrel bi-metallic extruders are formed using twin barrel segments have two cylindrical intersecting bores that are bolted together to form a longer extrusion device. Due to precision problems in conventional manufacturing techniques, these segments are limited to a ratio of length to bore diameter of approximately 4:1.

The process of forming a twin bore barrel extruder segment begins with drilling a first axial bore hole in a piece of metal. The first bore hole is then plugged with a metal cylinder. A second axial bore hole is then drilled parallel to the first bore hole and intersecting the first bore hole. The plug is then cleared to expose the first bore hole. The length limitation on twin bore barrel segments is introduced by the difficulty in preventing the drill bit from wandering into the first bore hole during the drilling of the second bore hole.

After the two bore holes are formed, a bi-metallic liner is typically pressed into the bores. Using a pressed line results in a small air gap between the liner and the bore surface, which creates heat transfer problems. Centrifugal lining techniques cannot be used to line the two bore holes because the two intersecting axial bores are not symmetrical and centrifugal deposition of the liner will not result in a uniform bi-metallic liner layer. The two bore holes cannot be individually lined using separate centrifugal deposition steps for each bore because the liner must be hardened after deposition and the processing for one bore will effect the other bore. Also, a honing process is typically used to finish the liner and the honing process cannot be applied to the asymmetric intersecting bores. Another technique for lining a twin bore barrel using inductive heating is discussed in U.S. Pat. No. 6,881,934.

Each twin bore barrel segment has cooling channels drilled into the segment shell for cooling. Separate heating elements, which are the length of the segment, are attached to the outside. The separate heating and cooling elements are less effective in controlling temperature within the extruder segments. The separate segments must be carefully aligned and securely bolted together to form the desired length of the twin barrel extruder. The separate heating elements for each segment along the length of the twin barrel extruder also introduce inaccuracies in temperature due to variations in the different heater elements.

Some examples of conventional twin bore barrel extruders are shown in U.S. Pat. Nos. 5,000,900; 5,516,205; 6,059,440; and 6,179,459.

### BRIEF SUMMARY OF THE INVENTION

An embodiment of a method for producing a continuous bi-metallic twin bore barrel calls for forming a first single bore barrel, centrifugally lining the bore of the first single bore barrel with a bi-metallic liner, heating the first single bore barrel to harden the lining of the first single bore barrel, fastening the first single bore barrel to a first barrel machining jig, and cutting the first single bore barrel along its length to expose the bore of the first single bore barrel. The method also calls for forming a second single bore barrel, centrifugally lining the bore of the second single bore barrel with a bi-metallic liner, heating the second single bore barrel to harden the lining of the second single bore barrel, fastening the second single bore barrel to a second barrel machining jig, and cutting the second single bore barrel along its length to expose the bore of the second single bore barrel. The method then calls for fastening the first barrel machining jig to the second barrel machining jig such that the first and second single bore barrels are positioned adjacent and in contact with one another with the bore of the first single bore barrel in communication with the bore of the second single bore barrel. The method then calls for seal welding the first and second single bore barrels to form a twin bore barrel, removing the twin bore barrel from the jigs, and clamping the twin bore barrel along its length. An embodiment of a twin bore barrel is the barrel produced by this method.

An embodiment of a continuous bi-metallic twin bore barrel for a twin screw extruder includes a first portion having a first axial bore formed therein, the first axial bore having a centrifugally formed bi-metallic liner and a second portion having a second axial bore formed therein, the second axial bore having a centrifugally formed bi-metallic liner, where the first and second portions are seal welded together and the first and second axial bores are intersecting.

### BRIEF DESCRIPTION OF THE DRAWINGS

An exemplary embodiment of a continuous bi-metallic twin bore barrel, and the method for making the same, is described below with respect to the following drawings, wherein:

FIG. 1 is an end view showing a single bore barrel;

FIG. 2 is an end view showing the single bore barrel of FIG. 1 with a centrifugally deposited liner formed within the bore;

FIG. 3 is an end view showing the single bore barrel of FIG. 2 with securing points drilled into the outside surface of the barrel;

FIG. 4 is an end view showing the single bore barrel of FIG. 3 with a barrel machining jig fastened to the barrel via the securing points;

FIG. 5 is a perspective view showing the single bore barrel of FIG. 4 after a portion of the barrel has been cut away;

FIG. 6 is a perspective view showing two cut away single bore barrels of FIG. 5 and their associated jigs secured and seal welded to form a twin bore barrel;

FIG. 7 is an end view showing the twin bore barrel of FIG. 6 with a structural bolting clamp mounted over the end of the barrel;

FIG. 8 is a side view of the twin bore barrel of FIG. 7 showing a structural bolting clamp mounted at each end of the barrel and several structural clamps mounted along the length of the barrel.

### DETAILED DESCRIPTION OF THE INVENTION

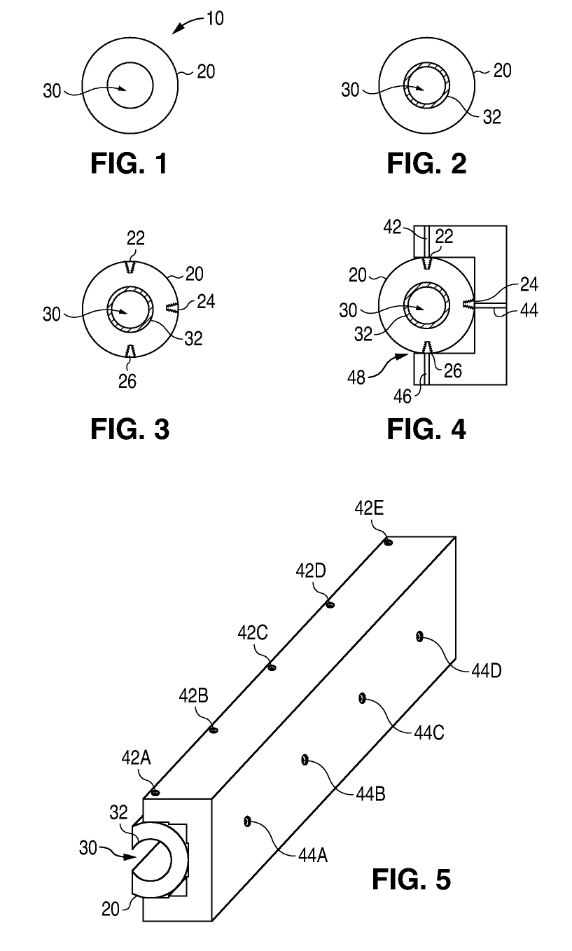

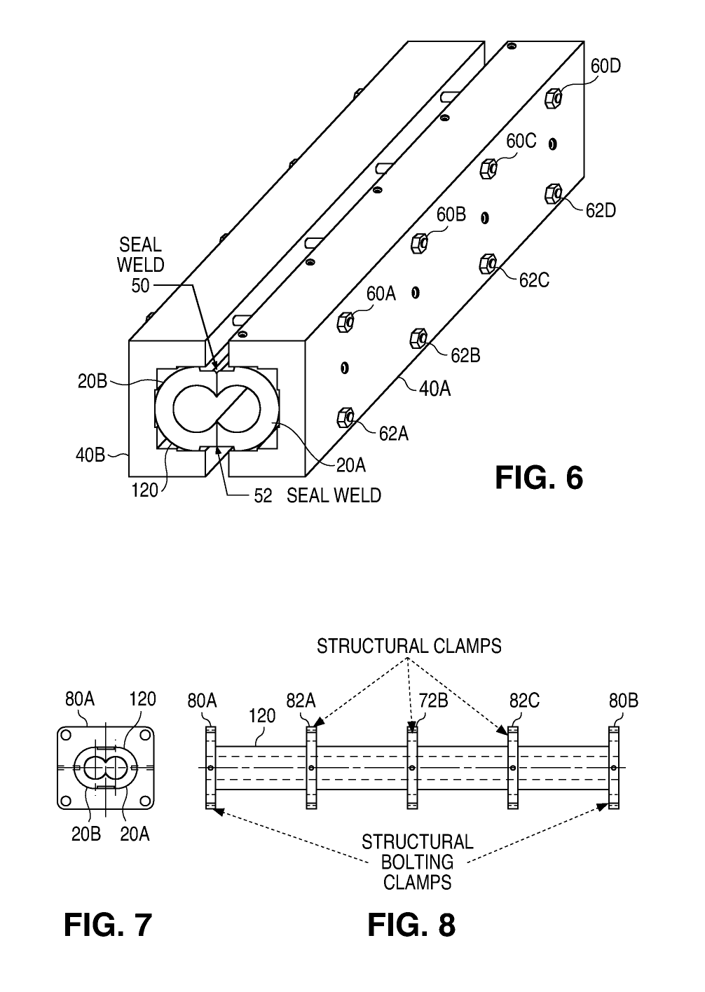

An exemplary embodiment of a continuous bi-metallic twin bore barrel, such as for a twin screw extruder, is produced by first making two separate single bore bi-metallic barrels. As shown in FIG. 1, in this example, each single bore barrel starts with a metal cylinder 20 of the desired length that is bored out, e.g. by honing, to produce a single axial bore 30 along the length of cylinder 20. In FIG. 2, a bi-metallic liner 32 is then centrifugally deposited along the surface of the bore 30 and the cylinder 20 is heated to harden the liner 32. These steps are essentially the same process used to produce conventional continuous single bore bi-metallic barrels.

In FIG. 3, fastening points 22, 24 and 26 are formed in the wall of barrel 20. In this example, the fastening points 22, 24 and 26 are threaded holes drilled and tapped into the outside surface of barrel 20 along the length of the barrel. In FIG. 4, a barrel machining jig 40, having attachment points 42, 44 and 46 along the length of jig 40, is fastened to barrel 20 at fastening points 22, 24 and 26. Attachment points 42, 44 and 46 of jib 40 are aligned with fastening points 22, 24 and 26 of barrel 20. An opening 48 in jig 40 accommodates the positioning of barrel 20 within jig 40.

After securing within jig 40, a portion of barrel 20 is positioned outside of jig 40 so that the wall of barrel 20 may be cut so that the bore is exposed along the length of the barrel. In a preferred embodiment, barrel 20 is cut in a single plane that intersects axial bore 30. The resulting cut away single axial bore barrel with a planar cut wall is illustrated in FIG. 5. After cutting, jig 40 prevents the cut away barrel 20 from deflecting or curling after the wall of the barrel is cut. The planar cut walls of two such cut away single bore barrels 20A and 20B are placed together and their associated jigs 40A and 40B are fastened together so that the two single bore barrels can be seal welded together to form a twin bore barrel 120. Jigs 40A and 40B are fastened together via fasteners 60A-D and 62A-D, which are bolts in this example. Corresponding through holes are formed in jigs 40A and 40B to accommodate fasteners 60A-D and 62A-D. While jigs 40A and 40B are fastened together, seal welds 50 and 52 are formed along the length of single bore barrels 20A and 20B to join the two single bore barrels. Once the seal welds 50 and 52 are formed, fasteners 60A-D and 62A-D may be removed and twin bore barrel 120 is removed from jigs 40A and 40B.

To provide additional strength, clamps are mounted along the length of twin bore barrel 120. As shown in FIGS. 7 and 8, structural bolting clamps 80A and 80B are mounted at the ends of twin bore barrel 120 and, in this example, provide through holes for fastening other components to the twin bore barrel 120 in order to construct a twin bore barrel extruder. As shown in FIG. 8, structural clamps 82A-C are mounted between structural bolting clamps 80A and 80B along the length of twin bore barrel 120. The number of clamps utilized may vary. The required clamping interval largely depends upon the diameter of the barrel bores and is engineered for each application, as is understood by one of ordinary skill in the art.

In a preferred embodiment, clamps 80A-B and 82A-C are formed with an opening that matches a cross-section of twin bore barrel 120, but is slightly smaller. The clamps 80A-B and 82A-C are mounted on the barrel by heating the clamps, sliding or press fitting them into position along the length of twin bore barrel 120, and allowing the clamps to cool and contract, thereby securing the clamps in place on the barrel. The size of the opening in the clamps and the coefficient of thermal expansion of the metal for the clamps are selected so that the clamps will expand enough when heated to permit them to fit onto barrel 120. In other words, the clamps are formed so that the opening in the clamps is smaller than the cross-section of barrel 120 when the clamps are cool, e.g. at the operating temperature for a plastic extruder, and larger than the cross-section of barrel 120 when the clamps are heated. Note that in this preferred embodiment, the clamps remain in their plastic deflection zone.

Typical safety requirements require that the barrels withstand up to 10,000 pounds-per-square-inch (PSI) of pressure. The clamps should, therefore, preferably withstand 10,000 PSI. The use of clamshell type temperature control units, which is possible with many embodiments of the present twin bore barrel and which typically utilize a clamping type mechanism, can further contribute to the pressure safety margin of the present twin bore barrel.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method for producing a continuous bi-metallic twin bore barrel for a twin screw extruder, the method comprising the steps of:
forming a first single bore barrel;
centrifugally lining the bore of the first single bore barrel with a bi-metallic liner;
heating the first single bore barrel to harden the lining of the first single bore barrel;
fastening the first single bore barrel to a first barrel machining jig;
cutting the first single bore barrel along its length to expose the bore of the first single bore barrel;
forming a second single bore barrel;
centrifugally lining the bore of the second single bore barrel with a bi-metallic liner;
heating the second single bore barrel to harden the lining of the second single bore barrel;
fastening the second single bore barrel to a second barrel machining jig;
cutting the second single bore barrel along its length to expose the bore of the second single bore barrel;
fastening the first barrel machining jig to the second barrel machining jig such that the first and second single bore barrels are positioned adjacent and in contact with one another with the bore of the first single bore barrel in communication with the bore of the second single bore barrel;
seal welding the first and second single bore barrels to form a twin bore barrel;
removing the twin bore barrel from the jigs; and
clamping the twin bore barrel along its length.

2. The method of claim 1, where the step of clamping the twin bore barrel along its length further comprises the steps of:
forming a plurality of clamps, where each clamp has an opening that matches a cross-section of the twin bore barrel and the opening is smaller than the cross-section of the twin bore barrel when the clamp is at an operating temperature for a plastic extruder and larger than the cross-section of the twin bore barrel when the clamp is heated;
heating each of the clamps; and
fitting each clamp onto the twin bore barrel while the clamp is heated.

3. The method of claim 1, where the method further comprises the steps of:
forming fastener points along the first single bore barrel; and
forming fastener points along the second single bore barrel;
wherein:
the step of fastening the first single bore barrel to a first barrel machining jig further comprises fastening the first single bore barrel to the first barrel machining jig at the fastener points along the first single bore barrel; and
the step of fastening the second single bore barrel to a second barrel machining jig further comprises fastening the second single bore barrel to the second barrel machining jig at the fastener points along the second single bore barrel.

4. The twin bore barrel produced by the method of claim 1.

5. The twin bore barrel produced by the method of claim 2.

6. A continuous bi-metallic twin bore barrel for a twin screw extruder, the barrel comprising:
a first portion having a first axial bore formed therein, the first axial bore having a centrifugally formed bi-metallic liner;
a second portion having a second axial bore formed therein, the second axial bore having a centrifugally formed bi-metallic liner, where the first and second portions are seal welded together to form the twin bore barrel and the first and second axial bores are intersecting; and
a plurality of clamps disposed along the twin bore barrel, where each clamp has an opening that matches a cross-section of the twin bore barrel and an opening formed in each clamp is smaller than the cross-section of the twin bore barrel when the clamp is at an operating temperature for a plastic extruder and the opening is larger than the cross-section of the twin bore barrel when the clamp is heated.
